(19) United States
(12) Patent Application Publication
(10) Pub. No.: US 2019/0382643 A1
(43) Pub. Date: Dec. 19, 2019

(54) METHODS FOR TREATING FRACTURE FACES IN PROPPED FRACTURES USING FINE PARTICULATES

(71) Applicant: Halliburton Energy Services, Inc., Houston, TX (US)

(72) Inventors: Philip D. Nguyen, Houston, TX (US); Ronald Glen Dusterhoft, Katy, TX (US); Loan K. Vo, Houston, TX (US); Kenneth E. Williams, Houston, TX (US); Vladimir Nikolayevich Martysevich, Spring, TX (US)

(21) Appl. No.: 16/464,102

(22) PCT Filed: Dec. 28, 2016
(86) PCT No.: PCT/US2016/068934

§ 371 Date: May 24, 2019

(51) Int. Cl. C09K 8/575; C09K 8/57; C09K 8/84

(52) U.S. Cl. CPC C09K 8/5751; C09K 8/845; C09K 8/572

(57) ABSTRACT

Methods and compositions for mitigating the embedment of proppant into fracture faces in subterranean formations are provided. In some embodiments, the methods comprise: introducing a treatment fluid into a subterranean formation at or above a pressure sufficient to create or enhance one or more fractures in the subterranean formation; introducing an anchoring agent into the subterranean formation to deposit the anchoring agent on a portion of a fracture face in the one or more fractures within the subterranean formation; introducing a first particulate material comprising fine particulates into the subterranean formation to attach to the anchoring agent on the portion of the fracture face, wherein said fine particulates have a mean particle size of up to about 50 μm; introducing a second particulate material comprising proppant into the one or more fractures in the subterranean formation.

### BACKGROUND

The present disclosure relates to systems and methods for treating subterranean formations.

Wells in hydrocarbon-bearing subterranean formations are often stimulated to facilitate the production of those hydrocarbons using hydraulic fracturing treatments. In hydraulic fracturing treatments, a viscous fracturing fluid, which also may function as a carrier fluid, is pumped into a producing zone at a rate and pressure such that one or more fractures are formed in the zone. In order to maintain sufficient conductivity through the fracture, it is often desirable that the formation surfaces within the fracture or “fracture faces” be able to resist erosion and/or migration to prevent the fracture from narrowing or fully closing. Typically, proppant particulates suspended in a portion of the fracturing fluid or other fluid are also deposited in the fractures when the fluid is converted to a thin fluid and returned to the surface. These proppant particulates serve to prevent the fractures from fully closing so that conductive channels are formed through which hydrocarbons can flow.

Shale formations with ductile characteristics may deform under high closure stresses, especially when exposed to water. When this happens, the proppant particulates can become embedded into the ductile formation or the formation material can invade into the proppant pack, thus diminishing the propped fracture width. Production of wells with fracture treatments performed in ductile shales, such as the Eagle Ford shale play, or many shale plays in China, may decrease soon after the fracturing treatment at least in part because of this phenomenon.

### BRIEF DESCRIPTION OF THE DRAWINGS

These drawings illustrate certain aspects of some of the embodiments of the present disclosure, and should not be used to limit or define the claims.

FIG. 1 is a diagram illustrating an example of a fracturing system that may be used in accordance with certain embodiments of the present disclosure.

FIG. 2 is a diagram illustrating an example of a subterranean formation in which a fracturing operation may be performed in accordance with certain embodiments of the present disclosure.

FIGS. 3A, 3B, 3C, and 3D are diagrams illustrating a portion of a subterranean formation during a treatment according to certain embodiments of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF CERTAIN EMBODIMENTS

The present disclosure relates to methods for treating subterranean formations. More particularly, the present disclosure relates to methods and compositions for mitigating the embedment of proppant into fracture faces in subterranean formations.

The present disclosure provides methods for mitigating proppant embedment using an anchoring agent to attach fine particulates to a portion of a fracture face in certain subterranean formations (e.g., ductile or weakly consolidated formations) before placement of proppant inside the fractures. In some embodiments, the fine particulates and/or anchoring agent may form a permeable membrane on the fracture face, which may mitigate proppant embedment into the fracture face while still permitting the flow of fluids therethrough. Further, an emulsion composition comprising fine particulates that are encapsulated, coated, or partially coated in a discontinuous phase that also comprises anchoring agent is disclosed for use in treating fracture faces in the formation.

Among the many potential advantages to the methods and compositions of the present disclosure, only some of which are alluded to herein, the methods and compositions of the present disclosure can help mitigate proppant embedment into ductile fracture faces and thereby maintain the effective propped fracture width for a highly conductive flow path. Also, the methods and compositions disclosed herein can help to facilitate placement of fine particulates into subterranean micro-fractures, which increase the surface area available for hydrocarbon production. Further, the methods and compositions disclosed herein may enhance the vertical distribution of the proppant pack. Moreover, the methods and compositions disclosed herein may provide for more effective stimulation of soft and/or ductile formations.

In certain methods of the present disclosure, a treatment fluid is provided. The treatment fluid is introduced into a subterranean formation at or above a pressure sufficient to create or enhance one or more fractures in the subterranean formation. An anchoring agent is introduced into the subterranean formation. The anchoring agent becomes deposited on a portion of a fracture face in the one or more fractures within the subterranean formation. A first particulate material comprising fine particulates is introduced into the subterranean formation. The fine particulates have a mean particle size of up to about 50 μm. The fine particulates are able to attach to the anchoring agent and/or the formation particles, which may form a permeable membrane along the fracture face. After the treatment fluid is introduced into the subterranean formation, a second particulate material comprising proppant is introduced into the subterranean formation.

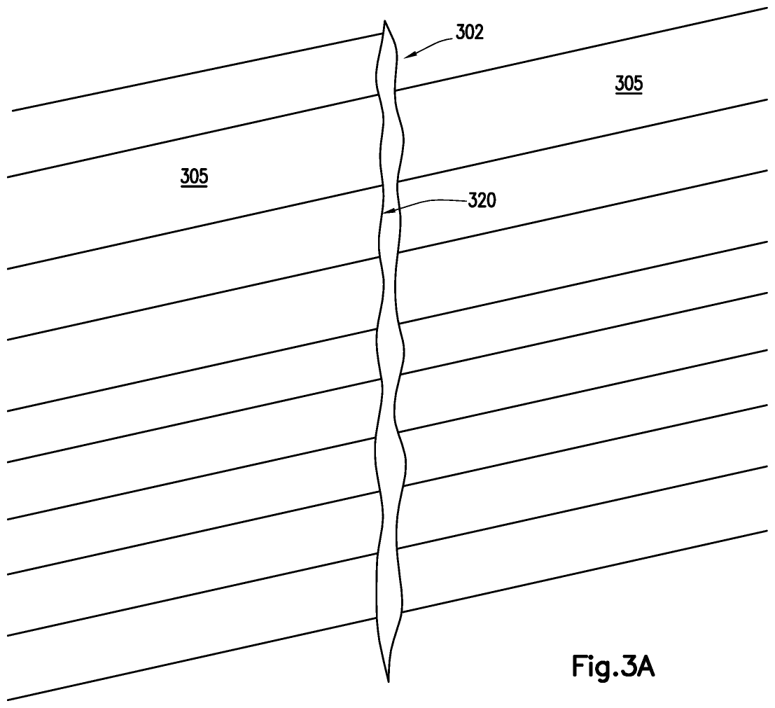

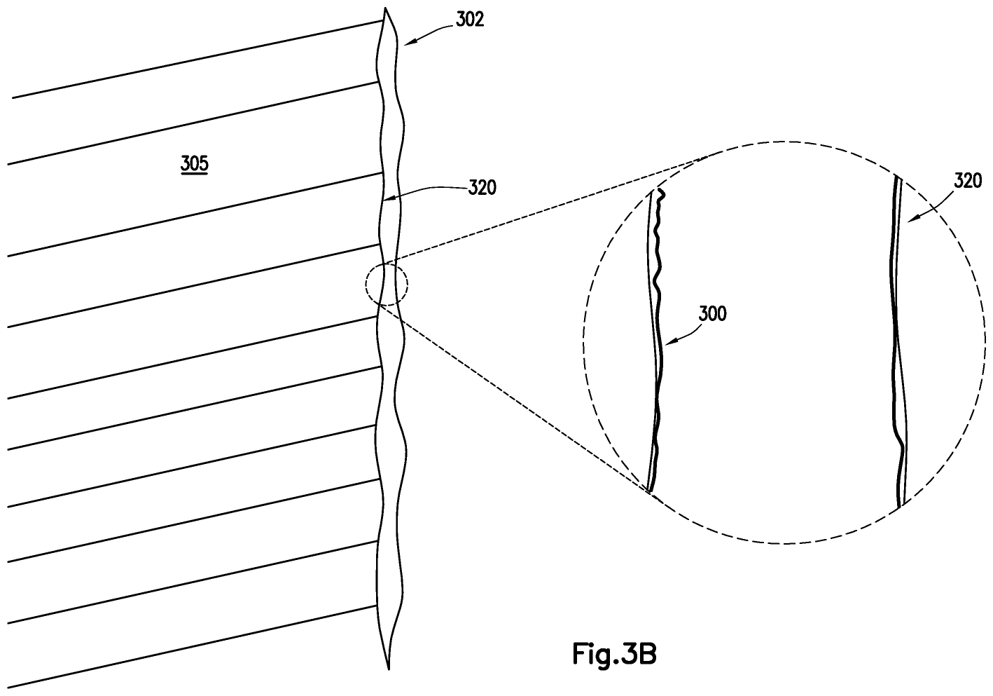

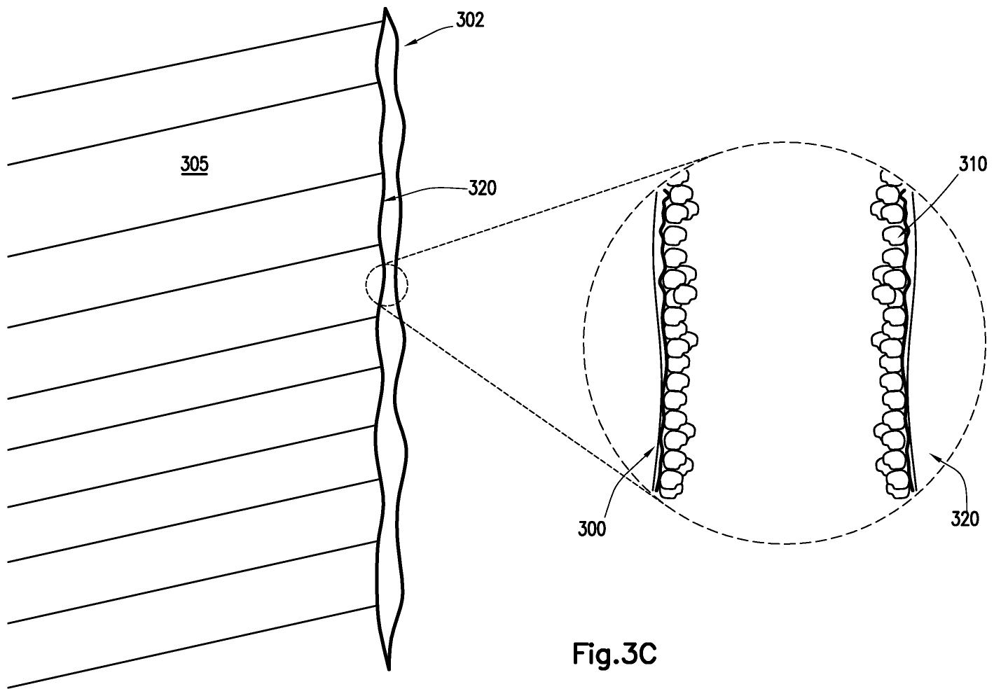

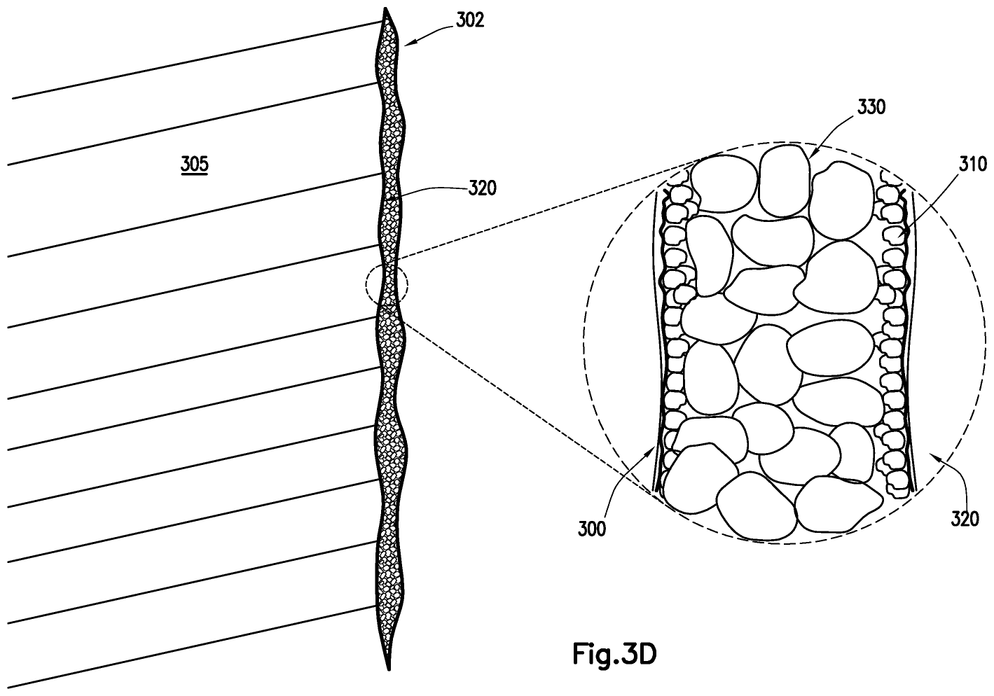

FIGS. 3A, 3B, 3C, and 3D (with their accompanying magnifications) illustrate a portion of a fracture in a subterranean formation as it is treated according to certain embodiments of the present disclosure. A portion of a fracture 302 is shown in a formation 305. In FIG. 3A, the fracture 302 is shown prior to treatment, having a fracture face 320 on the inner walls of the fracture. As shown in FIG. 3B, an anchoring agent 300 is introduced into the subterranean formation, which is deposited on a fracture face 320 of the fracture 302. Then, as shown in FIG. 3C, fine particulates 310 are introduced into the fracture 302 and attach to the anchoring agent 300 along the fracture face 320. The fine particulates 310 may form a permeable membrane along at least a portion of the fracture face 320, which may still permit the flow of fluids therethrough. In some embodiments, the anchoring agent and the fine particulates may be introduced together, e.g., as part of an emulsion, and then be deposited on the fracture face 320 as described above. Referring now to FIG. 3D, proppant 330 is introduced into the fracture 302, which may prevent the fractures from fully closing so that conductive channels are formed through which hydrocarbons can flow. The treatment method disclosed may mitigate proppant embedment into the fracture face while still permitting the flow of fluids through the permeable membrane.

Treatment fluids can be used in a variety of subterranean treatment operations. As used herein, the terms “treat,” “treatment,” “treating,” and grammatical equivalents thereof refer to any subterranean operation that uses a fluid in conjunction with achieving a desired function and/or for a desired purpose. Use of these terms does not imply any particular action by the treatment fluid. Illustrative treatment operations can include, for example, fracturing operations, gravel packing operations, acidizing operations, scale dissolution and removal, consolidation operations, and the like. In some embodiments, the treatment fluid will contain the anchoring agent. In some embodiments, the treatment fluid will contain the proppant.

The anchoring agents used in the methods and fluids of the present disclosure may provide adhesive bonding between formation surfaces and/or particulates and fine particulates, or may help consolidate the formation particles themselves. In some embodiments, the formation of a permeable membrane comprising the fine particulates can prevent embedment of the proppant within the formation to reduce the potential negative impact on permeability and/or fracture conductivity. The anchoring agent can be part of the fracturing fluid or it can be provided in a separate fluid that is introduced into the wellbore. The amount of anchoring agent introduced into the subterranean formation may be determined based on the fracture face surface area.

No particular mechanism of attachment is implied by the term “anchoring agent.” In some embodiments according to this disclosure, the anchoring agent attaches to formation particles and fine particulates using electrostatic charge differentials. In another embodiment, the anchoring agent attaches to formation particles and fine particulates through a chemical reaction.

A non-exclusive list of possible anchoring agents that may be used in certain embodiments of this disclosure include, but are not limited to: resins, tackifiers, silane coupling agents, and any combinations thereof. Resins that may be suitable for use as anchoring agents of the present disclosure include all resins known in the art that are capable of forming a hardened, consolidated mass. Many such resins are commonly used in subterranean consolidation operations, and some suitable resins include two component epoxy based resins, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, polyester resins and hybrids and copolymers thereof, polyurethane resins and hybrids and copolymers thereof, acrylate resins, and mixtures thereof. Some suitable resins, such as epoxy resins, may be cured with an internal catalyst or activator so that when pumped down hole, they may be cured using only time and temperature. Other suitable resins, such as furan resins generally require a time-delayed catalyst or an external catalyst to help activate the polymerization of the resins if the cure temperature is low (e.g., less than 250° F.), but will cure under the effect of time and temperature if the formation temperature is above about 250° F., preferably above about 300° F. It is within the ability of one skilled in the art, with the benefit of this disclosure, to select a suitable resin for use in embodiments of the present disclosure and to determine whether a catalyst is required to trigger curing.

In some embodiments, compositions suitable for use as tackifying agents in the present disclosure may comprise any compound that, when in liquid form or in a solvent solution, will form a tacky, non-hardening coating upon a particulate. Tackifying agents suitable for use in the present disclosure include non-aqueous tackifying agents; aqueous tackifying agents; silyl-modified polyamides, and reaction products of an amine and a phosphate ester. In addition to encouraging particulates to form aggregates, the use of a tackifying agent may reduce particulate flow back once the particulates are placed into a subterranean formation. The tackifying agents are provided in an amount ranging from about 0.1% to about 5% by weight of the fine particulates, preferably ranging from about 0.5% to about 2.5% by weight of the fine particulates.

One type of tackifying agent suitable for use in the present disclosure is a non-aqueous tackifying agent. A particularly preferred group of tackifying agents comprise polyamides that are liquids or in solution at the temperature of the subterranean formation such that they are, by themselves, non-hardening when introduced into the subterranean formation. A particularly preferred product is a condensation reaction product comprised of commercially available polyacids and a polyamine. Such commercial products include compounds such as mixtures of C36 dibasic acids containing some trimer and higher oligomers and also small amounts of monomer acids that are reacted with polyamines. Other polyacids include trimer acids, synthetic acids produced from fatty acids, maleic anhydride, acrylic acid, and the like. Such acid compounds are commercially available from companies such as Witco Corporation, Union Camp, Chemtall, and Emery Industries. The reaction products are available from, for example, Champion Technologies, Inc. and Witco Corporation. Additional compounds which may be used as non-aqueous tackifying compounds include liquids and solutions of, for example, polyesters, polycarbonates and polycarbamates, natural resins such as shellac and the like.

Non-aqueous tackifying agents suitable for use in the present disclosure may be either used such that they form non-hardening coating or they may be combined with a multifunctional material capable of reacting with the non-aqueous tackifying agent to form a hardened coating. A “hardened coating” as used herein means that the reaction of the tackifying compound with the multifunctional material will result in a substantially non-flowable reaction product that exhibits a higher compressive strength in a consolidated agglomerate than the tackifying compound alone with the particulates. In this instance, the non-aqueous tackifying agent may function similarly to a hardenable resin. Multifunctional materials suitable for use in the present disclosure include, but are not limited to, aldehydes such as formaldehyde, dialdehydes such as glutaraldehyde, hemiacetals or aldehyde releasing compounds, diacid halides, dihalides such as dichlorides and dibromides, polyacid anhydrides such as citric acid, epoxides, furfuraldehyde, glutaraldehyde or aldehyde condensates and the like, and combinations thereof. In some embodiments of the present disclosure, the multifunctional material may be mixed with the tackifying compound in an amount of from about 0.01 to about 50 percent by weight of the tackifying compound to effect formation of the reaction product. In some preferable embodiments, the compound is present in an amount of from about 0.5 to about 1 percent by weight of the tackifying compound.

Solvents suitable for use with the non-aqueous tackifying agents of the present disclosure include any solvent that is compatible with the non-aqueous tackifying agent and achieves the desired viscosity effect. The solvents that can be used in the present disclosure preferably include those having high flash points (most preferably above about 125° F.). Examples of solvents suitable for use in the present disclosure include, but are not limited to, butylglycidyl ether, dipropylene glycol methyl ether, butyl bottom alcohol, dipropylene glycol dimethyl ether, diethyleneglycol methyl ether, ethyleneglycol butyl ether, methanol, butyl alcohol, isopropyl alcohol, diethyleneglycol butyl ether, propylene carbonate, d'limonene, 2-butoxy ethanol, butyl acetate, furfuryl acetate, butyl lactate, dimethyl sulfoxide, dimethyl formamide, fatty acid methyl esters, and combinations thereof. It is within the ability of one skilled in the art, with the benefit of this disclosure, to determine whether a solvent is needed to achieve a viscosity suitable to the subterranean conditions and, if so, how much.

Aqueous tackifying agents suitable for use in the present disclosure are not significantly tacky when placed onto a particulate, but are capable of being “activated” (that is destabilized, coalesced and/or reacted) to transform the compound into a sticky, tackifying compound at a desirable time. Such activation may occur before, during, or after the aqueous tackifying agent is placed in the subterranean formation. In some embodiments, a pretreatment may be first contacted with the surface of a particulate to prepare it to be coated with an aqueous tackifying agent. Suitable aqueous tackifying agents are generally charged polymers that comprise compounds that, when in an aqueous solvent or solution, will form a non-hardening coating (by itself or with an activator) and, when placed on a particulate, will increase the continuous critical resuspension velocity of the particulate when contacted by a stream of water. The aqueous tackifying agent may enhance the grain-to-grain contact between the individual particulates within the formation (be they proppant particulates, formation fines, or other particulates), helping bring about the consolidation of the particulates into a cohesive, flexible, and permeable mass.

Suitable aqueous tackifying agents include any polymer that can bind, coagulate, or flocculate a particulate. Also, polymers that function as pressure sensitive adhesives may be suitable. Examples of aqueous tackifying agents suitable for use in the present disclosure include, but are not limited to: acrylic acid polymers; acrylic acid ester polymers; acrylic acid derivative polymers; acrylic acid homopolymers; acrylic acid ester homopolymers (such as poly(methyl acrylate), poly (butyl acrylate), and poly(2-ethylhexyl acrylate)); acrylic acid ester co-polymers; methacrylic acid derivative polymers; methacrylic acid homopolymers; methacrylic acid ester homopolymers (such as poly(methyl methacrylate), poly(butyl methacrylate), and poly(2-ethylhexyl methacrylate)); acrylamido-methyl-propane sulfonate polymers; acrylamido-methyl-propane sulfonate derivative polymers; acrylamido-methyl-propane sulfonate co-polymers; and acrylic acid/acrylamido-methyl-propane sulfonate co-polymers, derivatives thereof, and combinations thereof. The term “derivative” as used herein refers to any compound that is made from one of the listed compounds, for example, by replacing one atom in the base compound with another atom or group of atoms.

Silyl-modified polyamide compounds suitable for use as a tackifying agent in the methods of the present disclosure may be described as substantially self-hardening compositions that are capable of at least partially adhering to particulates in the unhardened state, and that are further capable of self-hardening themselves to a substantially non-tacky state to which individual particulates such as formation fines will not adhere to, for example, in formation or proppant pack pore throats. Such silyl-modified polyamides may be based, for example, on the reaction product of a silating compound with a polyamide or a mixture of polyamides. The polyamide or mixture of polyamides may be one or more polyamide intermediate compounds obtained, for example, from the reaction of a polyacid (e.g., diacid or higher) with a polyamine (e.g., diamine or higher) to form a polyamide polymer with the elimination of water.

Yet another tackifying agent suitable for use in the present disclosure is a reaction product of an amine and a phosphate ester. The ratio of amine to phosphate ester combined to create the reaction product tackifying agent is preferably from about 1:1 to about 5:1, more preferably from about 2:1 to about 3:1. In some embodiments it may be desirable to combine the amine and phosphate ester in the presence of a solvent, such as methanol.

In some embodiments, the anchoring agent also acts as a consolidating agent that hardens the ductile formation. In some embodiments, a curable resin is combined with a tackifying agent, for among other reasons, to provide a delayed curable system that provides some degrees of consolidation or bond strength between the fine particulates and the formation particles, or between the fine particulates and the proppant particulates. In some embodiments, an excess amount of delayed curable resin that has been used to carry fine particulates is allowed to leak into the ductile formation to treat the formation material. In these embodiments, the cured resin solidifies in a portion of the ductile or weakly consolidated formation material along the fracture surfaces to consolidate and/or strengthen those materials.

In some embodiments, the fine particulates can be coated with the anchoring agent. In some embodiments, the anchoring agent is part of an emulsion that can be made ahead of time and stored before use. In some embodiments, the emulsion can be comprised of an aqueous-based anchoring agent wherein the fine particulates are encapsulated within an emulsion droplet. In another embodiment, the emulsion can be comprised of an aqueous-base curable resin wherein the fine particulates are encapsulated within an emulsion droplet.

The fine particulates introduced into the subterranean formation in the methods of the present disclosure may comprise any particulate material known in the art of an appropriate particle size. Examples of fine particulates according to this disclosure include, but are not limited to, silica, fly ash, ceramic particles, iron oxide particles, carbon tubes, cellulose fibers, glass particles, glass fibers and thermoplastic particles. In some embodiments, the fine particulates can be coated with the anchoring agent. In the embodiments of the present disclosure, the fine particulates have a mean particle size of up to about 50 μm. Nanoparticles, i.e. particles with a diameter of about 1 to 100 nanometers, may be considered fine particulates. The size and/or size distribution of the fine particulates for a particular application of the present disclosure may be chosen based on the size of the formation particles. In some embodiments, the fine particulates will have a particle size of 5 to 6 times the mean particle size of the formation particulates. The size of the fine particulates may be selected to provide effective bridging in preventing invasion of formation materials into the fine particulate pack or layer on the fracture face. In some embodiments, the amount of fine particulates introduced into the subterranean formation may be determined based on the fracture face surface area. The amount needed can be estimated based on the fracture type, and in some embodiments, the amount may be multiplied by some factor (e.g., two or more) in order to ensure that any micro-fractures in communication with the primary fractures are also propped by the fine particulates. In some embodiments, the fine particulates can be introduced into the subterranean formation as a component of the treatment fluid that is introduced at or above a pressure sufficient to create or enhance one or more fractures in the formation.

In the methods of the present disclosure, following the introduction of fine particulates into the subterranean formation, a second particulate material comprising proppant is introduced into the subterranean formation. The proppant may comprise any proppant material known in the art. Examples of proppant materials that may be suitable in certain embodiments include, but are not limited to, silica (sand), graded sand, Ottawa sands, Brady sands, Colorado sands; resin-coated sands; gravels; synthetic organic particles, nylon pellets, high density plastics, polytetrafluoroethylenes, rubbers, resins; ceramics, aluminosilicates; glass; sintered bauxite; quartz; aluminum pellets; ground or crushed shells of nuts, walnuts, pecans, almonds, ivory nuts, brazil nuts, and the like; ground or crushed seed shells (including fruit pits) of seeds of fruits, plums, peaches, cherries, apricots, and the like; ground or crushed seed shells of other plants (e.g., maize, corn cobs or corn kernels); crushed fruit pits or processed wood materials, materials derived from woods, oak, hickory, walnut, poplar, mahogany, and the like, including such woods that have been processed by grinding, chipping, or other techniques for forming particles; or combinations thereof. In some embodiments, the proppant will have a particle size distribution of 5-7 times the mean particle size of the fine particulates. This may provide effective bridging within the subterranean formation for preventing invasion of formation materials into the proppant pack. In some embodiments, the particle size of the proppant introduced into the subterranean formation is gradually increased from medium- to coarse-sized fracturing sand or other proppant. The gradual increase in particle size may facilitate placement of the particles in the dominant fracture and larger branches. In some embodiments, the proppant can be introduced into the formation as a component of the fracturing fluid.

After the proppant is introduced into the subterranean formation, the fracture may be allowed to close and hold the proppant in place between the fracture faces that have been treated with fine particulates.

In another aspect of the present disclosure, an emulsion that may be used to treat a subterranean fracture face, among other reasons, to mitigate the embedment of proppant in the fracture face, is disclosed. The emulsion comprises a solid phase comprising fine particulates. The fine particulates have a mean particle size of up to about 50 μm. The emulsion further comprises a discontinuous phase that comprises a non-aqueous fluid and an anchoring agent. The emulsion further comprises continuous phase is comprised of an aqueous fluid. In the emulsion, at least a plurality of the fine particulates are encapsulated by the discontinuous phase. The anchoring agent contained in the discontinuous phase and the fine particulates of the solid phase may form a permeable membrane on the fracture face when the emulsion is introduced into a subterranean formation.

The treatment fluids used in the methods and systems of the present disclosure may comprise any base fluid known in the art, including aqueous base fluids, non-aqueous base fluids, and any combinations thereof. The term “base fluid” refers to the major component of the fluid (as opposed to components dissolved and/or suspended therein), and does not indicate any particular condition or property of that fluids such as its mass, amount, pH, etc. Aqueous fluids that may be suitable for use in the methods and systems of the present disclosure may comprise water from any source. Such aqueous fluids may comprise fresh water, salt water (e.g., water containing one or more salts dissolved therein), brine (e.g., saturated salt water), seawater, or any combination thereof. In most embodiments of the present disclosure, the aqueous fluids comprise one or more ionic species, such as those formed by salts dissolved in water. For example, seawater and/or produced water may comprise a variety of divalent cationic species dissolved therein. In certain embodiments, the density of the aqueous fluid can be adjusted, among other purposes, to provide additional particulate transport and suspension in the compositions of the present disclosure. In certain embodiments, the pH of the aqueous fluid may be adjusted (e.g., by a buffer or other pH adjusting agent) to a specific level, which may depend on, among other factors, the types of viscosifying agents, acids, and other additives included in the fluid. One of ordinary skill in the art, with the benefit of this disclosure, will recognize when such density and/or pH adjustments are appropriate. Examples of non-aqueous fluids that may be suitable for use in the methods and systems of the present disclosure include, but are not limited to, oils, hydrocarbons, organic liquids, and the like. In certain embodiments, the fracturing fluids may comprise a mixture of one or more fluids and/or gases, including but not limited to emulsions, foams, and the like.

In certain embodiments, the treatment fluids used in the methods and compositions of the present disclosure optionally may comprise any number of additional additives. Examples of such additional additives include, but are not limited to, salts, surfactants, acids, spacers, diverting agents, fluid loss control additives, gas, nitrogen, carbon dioxide, surface modifying agents, gelling agents, foamers, corrosion inhibitors, scale inhibitors, catalysts, clay control agents, biocides, friction reducers, antifoam agents, bridging agents, flocculants, additional H₂S scavengers, CO₂ scavengers, oxygen scavengers, lubricants, additional viscosifiers, breakers, weighting agents, relative permeability modifiers, resins, wetting agents, coating enhancement agents, filter cake removal agents, antifreeze agents (e.g., ethylene glycol), and the like. In certain embodiments, one or more of these additional additives (e.g., a crosslinking agent) may be added to the treatment fluid and/or activated after the viscosifying agent has been at least partially hydrated in the fluid. A person skilled in the art, with the benefit of this disclosure, will recognize the types of additives that may be included in the fluids of the present disclosure for a particular application.

The treatment fluids and/or emulsions of the present disclosure may be prepared using any suitable method and/or equipment (e.g., blenders, mixers, stirrers, etc.) known in the art at any time prior to their use. The treatment fluids and/or emulsions may be prepared at least in part at a well site or at an offsite location. In certain embodiments, the treatment fluids can be introduced in a dry or slurried state. In certain embodiments, the anchoring agent and/or other components of the treatment fluid and/or emulsion may be metered directly into a base treatment fluid to form a treatment fluid. In certain embodiments, the base fluid may be mixed with the fine particulates and/or other components of the treatment fluid and/or emulsion at a well site where the operation or treatment is conducted, either by batch mixing or continuous (“on-the-fly”) mixing. The term “on-the-fly” is used herein to include methods of combining two or more components wherein a flowing stream of one element is continuously introduced into a flowing stream of another component so that the streams are combined and mixed while continuing to flow as a single stream as part of the on-going treatment. Such mixing can also be described as “real-time” mixing. In other embodiments, the treatment fluids or emulsions of the present disclosure may be prepared, either in whole or in part, at an offsite location and transported to the site where the treatment or operation is conducted. In introducing a treatment fluid of the present disclosure into a portion of a subterranean formation, the components of the treatment fluid may be mixed together at the surface and introduced into the formation together, or one or more components may be introduced into the formation at the surface separately from other components such that the components mix or intermingle in a portion of the formation to form a treatment fluid. In either such case, the treatment fluid is deemed to be introduced into at least a portion of the subterranean formation for purposes of the present disclosure.

The present disclosure provides methods for using the treatment fluids to carry out hydraulic fracturing treatments. In certain embodiments, one or more treatment fluids (e.g., pad fluids, pre-pad fluids, other fluids) may be introduced into a subterranean formation, for example, through a well bore that penetrates a subterranean formation. In these embodiments, one or more of the treatment fluids may be introduced at a pressure sufficient to create or enhance one or more fractures within the subterranean formation.

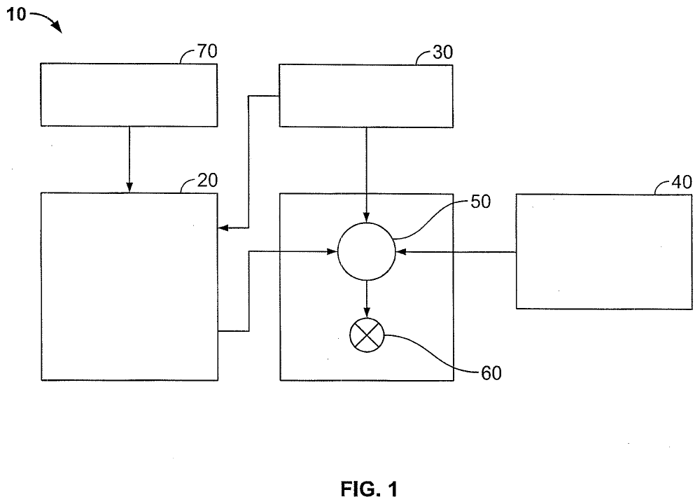

Certain embodiments of the methods and compositions disclosed herein may directly or indirectly affect one or more components or pieces of equipment associated with the preparation, delivery, recapture, recycling, reuse, and/or disposal of the disclosed compositions. For example, and with reference to FIG. 1, the disclosed methods and compositions may directly or indirectly affect one or more components or pieces of equipment associated with an exemplary fracturing system 10, according to one or more embodiments. In certain instances, the system 10 includes a fracturing fluid producing apparatus 20, a fluid source 30, a proppant source 40, and a pump and blender system 50 and resides at the surface at a well site where a well 60 is located. In certain instances, the fracturing fluid producing apparatus 20 combines a gel pre-cursor with fluid (e.g., liquid or substantially liquid) from fluid source 30, to produce a hydrated fracturing fluid that is used to fracture the formation. The hydrated fracturing fluid can be a fluid for ready use in a fracture stimulation treatment of the well 60 or a concentrate to which additional fluid is added prior to use in a fracture stimulation of the well 60. In other instances, the fracturing fluid producing apparatus 20 can be omitted and the fracturing fluid sourced directly from the fluid source 30. In certain instances, the fracturing fluid may comprise water, a hydrocarbon fluid, a polymer gel, foam, air, wet gases and/or other fluids.

The proppant source 40 can include a proppant for combination with the fracturing fluid. The system may also include additive source 70 that provides one or more additives (e.g., gelling agents, weighting agents, and/or other optional additives) to alter the properties of the treatment fluid. For example, the other additives 70 can be included to reduce pumping friction, to reduce or eliminate the fluid's reaction to the geological formation in which the well is formed, to operate as surfactants, and/or to serve other functions.

The pump and blender system 50 receives the fracturing fluid and combines it with other components, including proppant from the proppant source 40 and/or additional fluid from the additives 70. The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, fluid source 30, and/or proppant source 40 may be equipped with one or more metering devices (not shown) to control the flow of fluids, proppants, and/or other compositions to the pumping and blender system 50. Such metering devices may permit the pumping and blender system 50 can source from one, some or all of the different sources at a given time, and may facilitate the preparation of fracturing fluids in accordance with the present disclosure using continuous mixing or “on-the-fly” methods. Thus, for example, the pumping and blender system 50 can provide just fracturing fluid into the well at some times, just proppants at other times, and combinations of those components at yet other times.

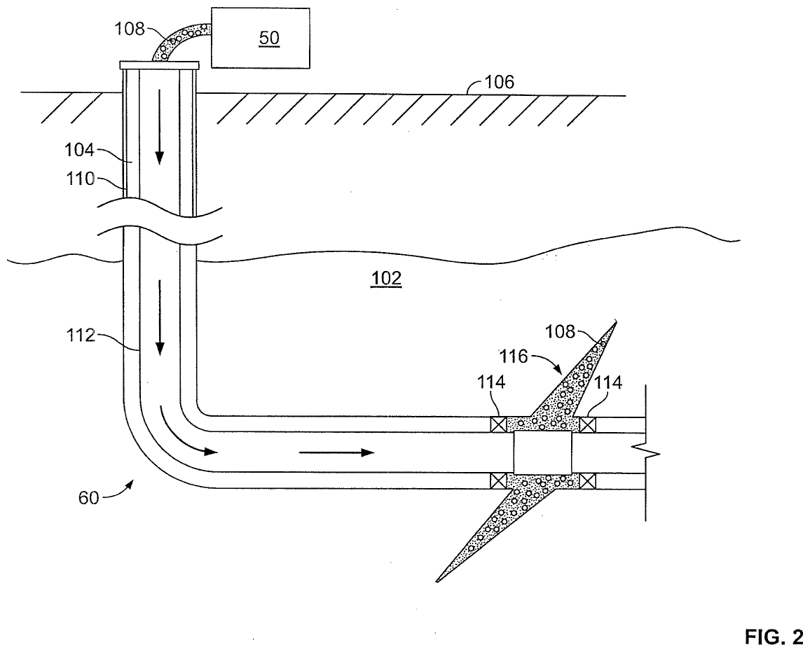

FIG. 2 shows the well 60 during a fracturing operation in a portion of a subterranean formation of interest 102 surrounding a well bore 104. The well bore 104 extends from the surface 106, and the fracturing fluid 108 is applied to a portion of the subterranean formation 102 surrounding the horizontal portion of the well bore. Although shown as vertical deviating to horizontal, the well bore 104 may include horizontal, vertical, slant, curved, and other types of well bore geometries and orientations, and the fracturing treatment may be applied to a subterranean zone surrounding any portion of the well bore. The well bore 104 can include a casing 110 that is cemented or otherwise secured to the well bore wall. The well bore 104 can be uncased or include uncased sections. Perforations can be formed in the casing 110 to allow fracturing fluids and/or other materials to flow into the subterranean formation 102. In cased wells, perforations can be formed using shape charges, a perforating gun, hydro-jetting and/or other tools.

The well is shown with a work string 112 depending from the surface 106 into the well bore 104. The pump and blender system 50 is coupled a work string 112 to pump the fracturing fluid 108 into the well bore 104. The working string 112 may include coiled tubing, jointed pipe, and/or other structures that allow fluid to flow into the well bore 104. The working string 112 can include flow control devices, bypass valves, ports, and or other tools or well devices that control a flow of fluid from the interior of the working string 112 into the subterranean zone 102. For example, the working string 112 may include ports adjacent the well bore wall to communicate the fracturing fluid 108 directly into the subterranean formation 102, and/or the working string 112 may include ports that are spaced apart from the well bore wall to communicate the fracturing fluid 108 into an annulus in the well bore between the working string 112 and the well bore wall.

The working string 112 and/or the well bore 104 may include one or more sets of packers 114 that seal the annulus between the working string 112 and well bore 104 to define an interval of the well bore 104 into which the fracturing fluid 108 will be pumped. FIG. 2 shows two packers 114, one defining an uphole boundary of the interval and one defining the downhole end of the interval. When the fracturing fluid 108 is introduced into well bore 104 (e.g., in FIG. 2, the area of the well bore 104 between packers 114) at a sufficient hydraulic pressure, one or more fractures 116 may be created in the subterranean zone 102. The proppant particulates in the fracturing fluid 108 may enter the fractures 116 where they may remain after the fracturing fluid flows out of the well bore. These proppant particulates may “prop” fractures 116 such that fluids may flow more freely through the fractures 116.

While not specifically illustrated herein, the disclosed methods and compositions may also directly or indirectly affect any transport or delivery equipment used to convey the compositions to the fracturing system 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

To facilitate a better understanding of the present disclosure, the following examples of certain aspects of certain embodiments are given. The following examples are not the only examples that could be given according to the present disclosure and are not intended to limit the scope of the disclosure or claims.

### EXAMPLE

A mixture containing water as a carrier fluid, 50 gpt of a slurry containing silica fines (d50˜5 μm) in a xanthan suspension and 50 gpt of aqueous external emulsion of Rhemod™ L viscosifier was prepared. Rhemod™ L viscosifier is a dimer acid that is only soluble in organic acid, available from Halliburton Energy Services, Inc. Forming an aqueous external emulsion of Rhemod™ L viscosifier allows it to be dispersible in an aqueous carrier fluid such as water or brine. The mixture appeared to be fully stable with the silica fines and Rhemod™ L viscosifier emulsion completely dispersed in the water. A 50 gpt of Sandtrap® ABC part A resin was added to the mixture. Sandtrap® ABC part A curable epoxy resin is available from Halliburton Energy Services, Inc. A curing reaction occurred when Sandtrap® ABC part A resin was exposed to the mixture containing Rhemod™ L viscosifier.

An Eagle Ford shale core was split into two halves to create a simulated fracture face. One half of the split core was submerged into a solution of 5% KCl, to be used as a comparsion. The other half of the split core was submerged into the mixture containing a 5% KCl solution, silica fines, Rhemod™ L viscosifier, and Sandtrap® ABC part A resin, and the fracture face was treated. In this mixture, Rhemod™ L viscosifier acted as a hardening agent that also offers some tackiness, and helps the silica fines to adhere to the fracture face. After 5 minutes of treatment, the treated half-core was placed in an oven for curing at 200° F. for 6 hours. Scanning electron microscopy pictures of the treated fracture face showed silica fines adhered onto the fracture face. The Brinell Hardness (BHN) of each half of the split core was then measured, which demonstrated the alteration of the hardness of the fracture face upon treatment.

| | Untreated BHN | Treated BHN |
|---|---|---|
| | (Kgf/mm²) | (Kgf/mm²) |
| Eagle Ford | 92 | 118 |

An embodiment of the present disclosure is a method comprising: introducing a treatment fluid into a subterranean formation at or above a pressure sufficient to create or enhance one or more fractures in the subterranean formation; introducing an anchoring agent into the subterranean formation to deposit the anchoring agent on a portion of a fracture face in the one or more fractures within the subterranean formation; introducing a first particulate material comprising fine particulates into the subterranean formation to attach to the anchoring agent on the portion of the fracture face, wherein said fine particulates have a mean particle size of up to about 50 μm; and introducing a second particulate material comprising proppant into the one or more fractures in the subterranean formation.

Another embodiment of the present disclosure is a system comprising: an emulsion comprising a solid phase comprising fine particulates, wherein said fine particulates have a mean particle size of up to about 50 μm; a discontinuous phase comprising a non-aqueous fluid and an anchoring agent; a continuous phase comprising an aqueous fluid; and wherein at least a plurality of the fine particulates are encapsulated, coated, or at least partially coated by the discontinuous phase.

Another embodiment of the present disclosure is a method comprising: pumping a treatment fluid into a subterranean formation at or above a pressure sufficient to create or enhance one or more fractures in the subterranean formation; pumping an emulsion treatment fluid into the subterranean formation, the emulsion treatment fluid comprising: an aqueous continuous phase, a plurality of silica fine particulates having a mean particle size of about 5 μm in a suspension comprising xanthan, an anchoring agent comprising a curable epoxy resin, and a dimer acid; depositing the anchoring agent on a portion of a fracture face in the one or more fractures within the subterranean formation; attaching at least a portion of the silica fine particulates to the anchoring agent on the portion of the fracture face; and pumping a particulate proppant material into the one or more fractures in the subterranean formation.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
introducing a treatment fluid into a subterranean formation at or above a pressure sufficient to create or enhance one or more fractures in the subterranean formation;
introducing an anchoring agent into the subterranean formation to deposit the anchoring agent on a portion of a fracture face in the one or more fractures within the subterranean formation;
introducing a first particulate material comprising fine particulates into the subterranean formation to attach to the anchoring agent on the portion of the fracture face, wherein said fine particulates have a mean particle size of up to about 50 μm; and
introducing a second particulate material comprising proppant into the one or more fractures in the subterranean formation.

2. The method of claim 1 wherein the treatment fluid comprises the anchoring agent.

3. The method of claim 1 wherein the treatment fluid comprises the proppant.

4. The method of claim 1 further comprising allowing the anchoring agent to consolidate at least a portion of unconsolidated particulates in the subterranean formation.

5. The method of claim 1 wherein the anchoring agent is operable to attach to at least a portion of the fracture face by an electrostatic charge difference.

6. The method of claim 1 wherein the anchoring agent comprises a curable resin.

7. The method of claim 1 wherein the anchoring agent is coated onto at least a portion of the fine particulates.

8. The method of claim 1 wherein the anchoring agent is part of an emulsion.

9. The method of claim 1 wherein the treatment fluid comprises the fine particulates.

10. The method of claim 1 wherein the treatment fluid further comprises a gelling agent.

11. The method of claim 1 wherein the proppant has a particle size of 5 to 7 times a mean particle size of the fine particulates.

12. The method of claim 1 wherein introducing the second particulate material into the subterranean formation comprises introducing proppant of gradually increasing particle sizes into the subterranean formation.

13. The method of claim 1 wherein the treatment fluid is introduced into a subterranean formation using one or more pumps.

14. An emulsion comprising:
a solid phase comprising fine particulates, wherein said fine particulates have a mean particle size of up to about 50 μm;
a discontinuous phase comprising a non-aqueous fluid and an anchoring agent; and
a continuous phase comprising an aqueous fluid;
wherein at least a plurality of the fine particulates are encapsulated or at least partially coated by the discontinuous phase.

15. The emulsion of claim 14 wherein the anchoring agent comprises a curable resin.

16. The emulsion of claim 14 wherein the anchoring agent is operable to attach to at least a portion of a fracture face by an electrostatic charge difference.

17. The emulsion of claim 14 wherein the anchoring agent is contained in the non-aqueous fluid.

18. A method comprising:
pumping a treatment fluid into a subterranean formation at or above a pressure sufficient to create or enhance one or more fractures in the subterranean formation;
pumping an emulsion treatment fluid into the subterranean formation, the emulsion treatment fluid comprising:
an aqueous continuous phase,
a plurality of silica fine particulates having a mean particle size of about 5 μm in a suspension comprising xanthan,
an anchoring agent comprising a curable epoxy resin, and
a dimer acid;
depositing the anchoring agent on a portion of a fracture face in the one or more fractures within the subterranean formation;
attaching at least a portion of the silica fine particulates to the anchoring agent on the portion of the fracture face; and
pumping a particulate proppant material into the one or more fractures in the subterranean formation.

19. The method of claim 18 wherein the aqueous continuous phase further comprises one or more salts.

20. The method of claim 18 wherein pumping the particulate proppant material into the subterranean formation comprises pumping proppant material of gradually increasing particle sizes into the subterranean formation.
